(19) United States
(12) Patent Application Publication
(10) Pub. No.: US 2025/0208938 A1
(43) Pub. Date: Jun. 26, 2025

(54) METHOD FOR OPERATING A SENSOR ARRANGEMENT AND SENSOR ARRANGEMENT AND APPARATUS FOR DATA PROCESSING AND DEVICE

(71) Applicant: Qlar Europe GmbH, Darmstadt (DE)

(72) Inventor: Viktor RAIS, Darmstadt (DE)

(73) Assignee: Qlar Europe GmbH, Darmstadt (DE)

(21) Appl. No.: 19/061,348

(22) Filed: Feb. 24, 2025

Related U.S. Application Data
(63) Continuation of application No. PCT/EP2023/070953, filed on Jul. 28, 2023.

(30) Foreign Application Priority Data
Aug. 23, 2022 (DE) 10 2022 121 211.4

(51) Int. Cl. G06F 11/07

(52) U.S. Cl. CPC G06F 11/076; G06F 11/0736; G06F 11/079

(57) ABSTRACT

A method for operating a sensor arrangement and an apparatus for data processing, which is suitable for carrying out such a method are provided. In addition, the invention relates to a sensor arrangement which is suitable for being used in such a method and/or interacting with such an apparatus, as well as to a device comprising such a sensor arrangement and/or such an apparatus.

This nonprovisional application is a continuation of International Application No. PCT/EP2023/070953, which was filed on Jul. 28, 2023, and which claims priority to German Patent Application No. 10 2022 121 211.4, which was filed in Germany on Aug. 23, 2022, and which are both herein incorporated by reference.

### BACKGROUND OF THE INVENTION

### Field of the Invention

The present invention relates to a method for operating a sensor arrangement. The present invention further relates to an apparatus for data processing that is suitable for carrying out such a method. Moreover, the invention relates to a sensor arrangement that is suitable for use in such a method and/or for cooperation with such an apparatus, and to a device that includes such a sensor arrangement and/or such an apparatus.

### Description of the Background Art

Processes, also and in particular in industrial environments, are becoming increasingly dependent on the availability of sensor data. Such sensor data may be recorded, for example, by the sensors of a sensor arrangement and used for controlling and/or regulating, for example, devices such as machines.

If, due to a defect of one or more sensors of such a sensor arrangement, invalid sensor data are processed or sensor data possibly are no longer available at all, this may result in significant limitations in the process flow. In the worst case, downtime threatens an entire production facility or portions thereof, which may have far-reaching economic consequences.

Reliable operation of sensor arrangements is therefore of major importance. However, ensuring reliable operation is becoming increasingly complex due to the large variety of different types of sensor arrangements and the growing number of sensors for each sensor arrangement.

### SUMMARY OF THE INVENTION

It is therefore an object of the present invention to overcome the described disadvantages of the prior art, and in particular to provide sensor arrangements that may be operated reliably and easily, but also in a cost-effective manner.

According to a first aspect, the object is achieved by the invention by use of a method for operating a sensor arrangement having a plurality of sensors, wherein sensor data from each sensor of the plurality of sensors are received as reception sensor data of the particular sensor and provided as original sensor data of the particular sensor for further data processing. When an error state in conjunction with at least one specific sensor of the plurality of sensors is identified, replacement sensor data are subsequently determined for the specific sensor, and instead of reception sensor data of the specific sensor are provided as original sensor data of the specific sensor.

The replacement sensor data are determined by use of at least one first trained data model with assistance from machine learning, wherein reception sensor data and/or original sensor data of at least one sensor which is selected from the plurality of sensors as an auxiliary sensor, and which is not the specific sensor, and/or data based thereon, are used as input data for the first trained machine learning data model.

The invention is thus based on the surprising finding that a process that relies on the sensor data of the sensors of a sensor arrangement may be reliably continued, even during a failure, temporary breakdown, or temporary malfunction of a sensor of the arrangement and/or of a transmission channel used for transmitting the sensor data, when the actual sensor data of the affected sensor are replaced, at least temporarily, by synthetic sensor data.

The time until the sensor data of the specific sensor are once again properly available may thus be reliably bridged, for example a time period until the sensor has been repaired or replaced by a new sensor and/or until the transmission channel for the sensor data is once again functioning without error.

In the event of faulty or even fully absent sensor data of the affected sensor, the ongoing process may thus be continued with little or no interruption. It is thus possible to operate the sensor arrangement with increased reliability, and thus to reliably avoid or at least reduce associated downtimes of the process that relies on the sensor data.

It has surprisingly been found that the synthetic data may be determined particularly reliably when they are ascertained at least on the basis of the sensor data of at least a portion of the other sensors of the arrangement in conjunction with a trained machine learning data model.

In other words, the specific (defective) sensor is temporarily replaced by a virtual sensor in the form of a trained machine learning data model, and the synthetic data of this virtual sensor are provided for the processing and used as a substitute for the actual sensor data of the specific sensor.

Stated another way, it has been recognized in particular that the actual defective sensor (the specific sensor) may be replaced, so to speak, by a virtual sensor, so that the virtual sensor can continue the operation instead of the actual sensor until the specific sensor is replaced or repaired. The virtual replacement sensor is then based on a machine learning data model.

It has been found to be particularly advantageous that the proposed method, at least in principle, may preferably be used regardless of the number of sensors of the arrangement and regardless of the type of sensors of the arrangement. The proposed method is thus usable for different sensor arrangements in a particularly flexible manner. In addition, the proposed method is also usable particularly easily with existing sensor arrangements, since the physical sensor arrangement does not have to be adapted for this purpose, or if so, only to a manageable extent. The method may thus also be advantageously used in a cost-effective manner in conjunction with existing sensor arrangements. The advantages of improved operation may thus be utilized in a variety of ways, both for existing and new sensor arrangements.

By use of the proposed method, technical sensor failures in devices, in particular machines, may be advantageously addressed. This is because processes (or functionalities or also other entities in general) that are dependent on the sensor data may continue to run in the usual way. The risk of an operational interruption may thus be reliably avoided or at least reduced.

For example, for a device such as a platform scale having a plurality of sensors, for example four load cells, if one of the sensors (load cells) fails, the device (platform scale) may continue to be used for an operation according to the proposed method, since due to the recourse to the virtual sensor, sensor data continue to be available to the failed sensor as a substitute. In the case of the platform scale, the total weight thus advantageously does not deviate from the true total weight by approximately 25%, for example, as in conventional situations.

It is noted that during error-free operation of the sensor arrangement, the received reception sensor data of each sensor are preferably identical to the provided original sensor data of the particular sensor. However, if due to an identified error state the replacement sensor data for the specific sensor are determined, and the replacement sensor data are provided as original sensor data of the specific sensor, the received reception sensor data of the specific sensor (if data are even received at all) and the provided original sensor data of the specific sensor may differ, and this is also generally advantageously the case.

The replacement sensor data may advantageously be provided as original sensor data for the specific sensor, instead of the reception sensor data of the specific sensor, until proper sensor data are once again received from the specific sensor, for example after an exchange or a repair of the specific sensor.

Invalid sensor data may be received from a sensor, for example, when the sensor has become detached from its measuring location, for example has completely or partially come loose and/or fallen off a device.

It is particularly advantageous when multiple or all sensors of the plurality of sensors, which are not the specific sensor, are selected as auxiliary sensors. The database for determining the replacement sensor data may thus become more meaningful since multiple sensors make a contribution.

The original sensor data of the auxiliary sensors, which in the present case are used as input data for the first trained machine learning data model, advantageously include or represent the reception sensor data that are received at that moment from the auxiliary sensors. The current circumstances of the sensor arrangement may thus be taken into account in a particularly reliable manner.

In an example, the first trained machine learning data model can be provided after the error state is identified. The model may subsequently be used satisfactorily for determining the replacement sensor data.

In an example, the replacement sensor data, in particular at least for the specific sensor, can be continuously determined using the first trained machine learning data model. In this case, the replacement sensor data may then be advantageously provided as original sensor data instead of the sensor data of the specific sensor when the error state is identified. In other words, a switchover to the replacement sensor data is made (only) upon identifying the error state. A sequence of original sensor data for the specific sensor may thus be provided with no or essentially no interruption.

The error state in conjunction with the specific sensor can be preferably identified at a first point in time.

The proposed method is particularly advantageous for operating a sensor arrangement of a conveying device, measuring device, weighing device, grinding device, mixing device, filtering device, screening device, drying device, and/or metering device.

The method can be computer-implemented and/or can be carried out using an apparatus for data processing that is configured for carrying out the method. This apparatus for data processing is discussed in greater detail below, wherein the statements made there correspondingly apply here, unless specified otherwise from the context.

A sensor arrangement can be understood to mean a collection of at least two or more sensors, advantageously of the same type, wherein their sensor data are preferably evaluated and/or processed within the scope of joint data processing.

All sensors of the arrangement can be mounted on a single device, for example to detect operating parameters and/or physical variables of the device and/or its parts.

In the present patent application, the terms “xth trained machine learning data model,” “trained xth machine learning data model,” and “xth machine learning data model in trained form” (where “xth” refers to “first,” “second,” or “third,” for example, depending on the situation) are preferably used synonymously, unless specified otherwise from the particular context.

Alternatively or additionally, it may be provided that the training of the first machine learning data model is carried out after the error state is identified.

The use of such a freshly trained data model may result in particularly meaningful replacement sensor data, so that particularly reliable operation of the sensor arrangement is possible despite a failed or defective sensor.

The training of the first machine learning data model is advantageously begun directly immediately or essentially immediately (i.e., less than 1 minute, less than 30 seconds, less than 10 seconds, less than 5 seconds, or less than 1 second) after the error state is identified. The data model may thus be provided particularly quickly in trained form and used for determining the replacement sensor data. At the same time, the most current sensor data possible may be used for the training, which may advantageously contribute to a reliable data model.

However, it may also be preferred for the training to begin with a delay after the error state is identified, and/or to be added to a task list containing tasks to be executed. In this way, instantaneous capacity utilization of the computer system responsible for the training may advantageously be variably taken into account. For example, the training may be begun, in particular within a defined or definable time window, as a function of the capacity utilization of the system and/or the availability of resources.

In an example, the training can be performed using the apparatus for data processing. A memory on which the trained data models are stored and/or from where they can be retrieved may also be provided in the apparatus.

It may also be provided that the training of the first machine learning data model is or has been carried out at least using historical sensor data, in particular historical reception sensor data, of the specific sensor, and/or historical sensor data, in particular historical reception sensor data, of at least one sensor, preferably of all sensors, of the at least one auxiliary sensor.

It has been shown that, based on appropriate historical sensor data, replacement sensor data may be reliably determined, in particular at least temporarily, in a particularly advantageous manner. This functions particularly well when the environmental conditions existing at the point in time of recording the historical sensor data have not changed, or have changed only to a limited extent, in the meantime.

For training the model, for example, the received reception sensor data of the specific sensor and of the auxiliary sensors of the arrangement are used prior to the failure. It is thus advantageously possible to a certain extent for the virtual sensor to estimate its raw data (and thus to estimate the raw data of the defective sensor) based on the raw data of the functioning sensors, in particular the selected auxiliary sensors.

The training of the first machine learning data model may encompass, for example, using at least historical sensor data, in particular historical reception sensor data, of the at least one auxiliary sensor (or of the plurality of auxiliary sensors) as input data for the data model, and/or using historical sensor data, in particular historical reception sensor data, of the specific sensor as truth data. The input data and the truth data are advantageously associated with one another.

Alternatively or additionally, it may be provided that the training of the first machine learning data model encompasses assuming a linear relationship between the historical sensor data of the specific sensor on the one hand and the historical sensor data of the auxiliary sensors on the other hand.

A linear relationship allows use of a data model that is implementable particularly satisfactorily and efficiently.

For example, for a sensor arrangement with four sensors, a linear relationship between the sensor data of a specific sensor S₁ and the sensor data from three auxiliary sensors S₂ through S₄ at a given point in time t is advantageously described by the relationship:

S₁(t)=a·S₂(t)+b·S₃(t)+c·S₄(t)+d.

Within the scope of the training of a machine learning data model that implements this relationship, in the present example, for example the coefficients a, b, c, and d could be determined, and after completion of the training, the trained machine learning data model could be provided. Thus, by use of the trained data model, the current reception sensor data (S₂ through S₄) of the three auxiliary sensors could be inserted into the equation together with the coefficients determined during the training, and the current replacement sensor data could be determined as the result (S₁).

In an example, the data model is a linear regression model, in particular a stepwise linear regression model. Using this type of model or as an alternative, the sensors of the plurality of sensors (and which are not the specific sensor) having the greatest informative value are advantageously selected as auxiliary sensors.

Alternatively or additionally, it may be provided that the historical sensor data of the specific sensor and the historical sensor data of the auxiliary sensors have been detected within the same time window.

The individual historical sensor data of the specific sensor and of all auxiliary sensors have in each case preferably been recorded at the same point in time, and all points in time preferably lie within the time window. For example, each sensor thus records a measured value per unit time (per second, for example). A measured value from each sensor is thus present per unit time. If the time window is 100 time units long, the sensor data of each sensor thus include 100 measured values in this case.

It may also be provided that the historical sensor data of the specific sensor and/or of the auxiliary sensors are the reception sensor data received during a defined or definable time period prior to identifying the error state, or are data of the particular sensors provided as original sensor data, wherein preferably (i) within the time period, no error state has been identified, either for the specific sensor or for one of the auxiliary sensors, and/or (ii) sensors of the plurality of sensors for which an error state has been identified within the time period are not selected as auxiliary sensors.

For example, the time period may end immediately upon the identification or even earlier, in particular with a defined or definable time offset.

The longer the time period that is selected, the more information concerning the individual sensors and their behavior and properties that is available as a database, on the basis of which the replacement sensor data may be determined, and/or on the basis of which the data model may be trained. With a shorter time period, the replacement sensor data may be advantageously determined based on the more recent sensor behavior. Thus, changes in the sensor properties that occur over the long term, for example due to changing environmental conditions or progressive sensor aging, may remain disregarded.

An advantageous time period is 30 days or shorter, preferably 14 days or shorter, preferably 7 days or shorter, preferably 3 days or shorter, preferably 1 day or shorter, preferably 12 hours or shorter, preferably 6 hours or shorter, preferably 3 hours or shorter, preferably 1 hour or shorter, and/or 1 minute or longer, preferably 1 hour or longer, preferably 3 hours or longer, preferably 6 hours or longer, preferably 9 hours or longer, preferably 12 hours or longer, preferably 1 day or longer, preferably 3 days or longer, preferably 7 days or longer, preferably 14 days or longer, preferably 30 days or longer.

By selecting as auxiliary sensors only those sensors for which no error state has been identified, a particularly robust database for determining the replacement sensor data, in particular for the training of the data model, may be provided.

It may also be provided that the sensor data, in particular the historical sensor data, of the specific sensor at least slightly correlate with the sensor data, in particular the historical sensor data, of each auxiliary sensor.

It is thus advantageously made possible for meaningful replacement sensor data to be determined, based on the sensor data of the auxiliary sensors.

Within the meaning of the present patent application, the data of the sensors preferably correlate at least slightly when an at least weak relationship between the data exists. The existing relationship may be determined, for example, via a correlation coefficient of the sensor data.

For example, a correlation coefficient may assume values of −1 through 1. For −1, a perfectly negative relationship advantageously exists between the sensor data, for 0 there is no relationship (at least no linear relationship, and thus preferably no relationship in the sense of the present definition) between the sensor data, and for 1 a perfectly positive relationship exists between the sensor data.

In an example, an at least weak correlation between the sensor data is present when a correlation coefficient, in particular with regard to its absolute value, of at least 0.1, preferably at least 0.2, preferably at least 0.3, preferably at least 0.4, preferably at least 0.5, preferably at least 0.6, preferably at least 0.7, preferably at least 0.8, preferably at least 0.9, preferably at least 0.95, between the particular sensor data exists.

Alternatively or additionally, it may be provided that an error state for the specific sensor is identified: (i) when sensor data are no longer received, at least temporarily, from the specific sensor, (ii) when the reception sensor data received from the specific sensor or a statistical value thereof are/is above or below a defined or definable threshold value, (iii) when the reception sensor data received from the specific sensor do not meet a defined or definable measure of quality, (iv) when a result of testing an electrical resistance of the specific sensor, in particular in the form of a load cell, indicates a defect of the sensor, and/or (v) when a value, in particular a maximum value, of a correlation between the received reception sensor data of the specific sensor and the received reception sensor data of at least one other sensor of the plurality of sensors, in particular of the auxiliary sensors, is above or below a defined or definable threshold value.

For example, receiving the reception sensor data from the specific sensor may be prevented by a disturbance or a failure of the transmission channel (a cable or a radio channel, for example). This is possible in particular in the case of a sensor from which the sensor data are received by data cable or by radio via the air interface.

The statistical value may be, for example, an average value of the sensor data, in particular over a defined or definable time period.

Such a measure of quality may be, for example, the noise behavior of the sensor and/or of the sensor data recorded by same. It may therefore be advantageously provided to test the sensor and/or the sensor data for noise behavior, and preferably to use a result of the test as a measure of quality.

The testing of the electrical resistance may be advantageously carried out, in particular continuously or temporarily, using a test device that is in, or brought into, operative connection with the sensor and/or that is indicated by same.

For example, in each case a correlation may also be carried out between the received reception sensor data of the specific sensor and the received reception sensor data from each of two or more than two, preferably all, the other sensors of the plurality of sensors, in particular the auxiliary sensors, and an error state may be identified when a defined or definable number of correlations (in each case between the sensor data of the specific sensor and the sensor data of another sensor) result in a value, in particular a maximum value, that is above or below a defined or definable threshold value.

Alternatively or additionally, it may be provided that after the error state is identified in conjunction with the specific sensor, a discontinuation of the error state in conjunction with the specific sensor is identified, and the reception sensor data of the specific sensor are subsequently once again received and/or provided as original sensor data of the specific sensor, and in particular the replacement sensor data are no longer provided as original sensor data of the specific sensor.

A return may thus be reliably and automatically made into a normal operating mode when the sensors, in particular the specific sensor, of the sensor arrangement once again deliver(s) proper sensor data, for example after replacement or repair of the specific sensor.

The discontinuation of the error state is preferably identified after the error state is detected, in particular at a second point in time after the first point in time.

In an example, the determined replacement sensor data are repeatedly compared, continuously and/or at intervals, to the reception sensor data received from the specific sensor, and based on a result of the comparison the discontinuation of the error state in conjunction with the specific sensor is established. The replacement sensor data delivered by the particular data model may thus also be used for an additional purpose, to recognize that the specific sensor is once again operating properly. A return may then be made to normal operation, and the received reception sensor data (from the specific sensor) may once again be provided as original sensor data (of the specific sensor).

It may also be provided that the reception sensor data from each sensor of the plurality of sensors are continuously received, that the reception sensor data are received in parallel from all sensors of the plurality of sensors, and/or that the result data of the first trained machine learning data model are used as replacement sensor data.

When sensor data of a sensor are continuously received, sensor data are advantageously received periodically from the sensor. For example, the sensor data may be digital values that are received at a certain clock frequency.

When sensor data of multiple sensors are received in parallel, the sensor data are advantageously received from the multiple sensors via one or more transmission channels in parallel.

Alternatively or additionally, it may be provided that for at least the specific sensor, a second machine learning data model in trained form is kept ready, and the determination of the replacement sensor data encompasses determining, by means of the second trained machine learning data model that is kept ready for the specific sensor, the replacement sensor data, in particular at least temporarily, preferably at least until the training of the first machine learning data model is completed, the second trained machine learning data model preferably being identical to the first trained machine learning data model.

By use of the second trained data model, after the error state is identified the replacement sensor data may be determined by means of the second trained data model without a large time offset, in particular without having to wait possibly until the training of the first data model is completed.

For example, the second trained data model may be used until the training of the first data model is completed, and after completion of the training of the first data model the replacement sensor data are then determined by means of the first trained data model (and in particular are no longer determined using the second trained machine learning data model). Alternatively, the second machine learning data model may be identical to the first machine learning data model. The (first/second) data model, via which the replacement sensor data are determined, is thus advantageously already kept ready for use in trained form at the point in time when the error state is identified. The replacement sensor data are then determined using this data model. It is then no longer absolutely necessary to change the trained data model for determining the replacement sensor data.

The reception sensor data and/or the original sensor data of at least one of the auxiliary sensors, preferably all auxiliary sensors, and/or data based thereon are preferably used, at least in part, as input data for the second trained machine learning data model, and/or the result data of the second trained machine learning data model are used as replacement sensor data.

The statements made with regard to the training of the first data model preferably correspondingly apply with regard to the training of the second data model. The corresponding features may therefore also be provided, individually or in any given combination, for the training of the second data model. It is naturally understood, however, that the reference point of the historical data in this case is no longer the identification of the error state, but, rather, is preferably established by the beginning of the training of the second data model. This means that reception sensor data that have been received prior to the stated training of the second data model or provided as original sensor data are advantageously to be understood in this regard as historical sensor data of the particular sensors.

The statements made with regard to the determination of the replacement sensor data using the first data model preferably correspondingly apply with regard to the determination of the replacement sensor data using the second data model. The corresponding features may therefore also be provided individually or in any given combination for the determination of the replacement sensor data using the second data model.

The second machine learning data model in trained form is advantageously already present during identification of the error state.

Such a second trained machine learning data model can be preferably kept ready in each case for each sensor of the arrangement.

It may also be provided that, for at least the specific sensor, a third machine learning data model in trained form is kept ready, the third trained machine learning data model preferably being identical to the second trained machine learning data model, and by use of the third trained machine learning data model, test sensor data for the specific sensor are determined at least temporarily, preferably continuously, and compared to the sensor data received from the specific sensor, and an error state for the specific sensor is identified based on a result of the comparison.

By use of the third trained data model, in a manner of speaking a virtual sensor regularly delivers comparison sensor data which may be checked against the sensor data of the specific sensor. Error states may thus be recognized in a particularly reliable manner.

For example, the third machine learning data model may be identical to the first and/or second machine learning data model. By use of the (first/second/third) data model, via which the test sensor data are provided, the replacement sensor data may then be provided seamlessly, beginning at the point in time when the error state is identified.

The reception sensor data and/or the original sensor data of at least one of the auxiliary sensors, preferably all auxiliary sensors, and/or data based thereon are preferably used, at least in part, as input data for the third trained machine learning data model, and/or the result data of the third trained machine learning data model are used as test sensor data and/or replacement sensor data.

The statements made with regard to the training of the first data model preferably correspondingly apply with regard to the training of the third data model. The corresponding features may therefore also be provided individually or in any given combination for the training of the third data model. It is naturally understood, however, that the reference point of the historical data in this case is no longer the identification of the error state, but, rather, is preferably established by the beginning of the training of the third data model. This means that reception sensor data that have been received prior to the stated training of the third data model or provided as original sensor data are advantageously to be understood in this regard as historical sensor data of the particular sensors.

The statements made with regard to the determination of the replacement sensor data using the first data model preferably correspondingly apply with regard to the determination of the test sensor data and/or the replacement sensor data using the third data model. The corresponding features may therefore also be provided individually or in any given combination for the determination of the test sensor data and/or replacement sensor data using the third data model.

Such a third trained machine learning data model is preferably kept ready in each case for each sensor of the arrangement.

Alternatively or additionally, it may be provided that the reception sensor data and/or the original sensor data are associated or associatable with the individual sensors in each case, and/or that the original sensor data are provided to a process, to a module, to a device, and/or in the form of a control signal.

For example, the reception sensor data and/or original sensor data may thus be sorted according to sensors, and/or the origin of the original sensor data is known to the individual sensors in some other way.

In general, the provision of the original sensor data may encompass the provision of the data for an entity (which may preferably be implemented in software, in hardware, or a combination of both). It is thus possible for other entities, such as software modules and/or hardware modules, processes, functionalities, software functions, and/or devices, such as facilities and machines, to access these sensor data and/or obtain these sensor data. It is particularly flexible when the original sensor data are provided as a control signal. Such a control signal may be digital and/or analog, for example. The control signal may optionally include multiple sub-control signals, in particular as many as the number of sensors in the arrangement. For example, in that case each sub-control signal may represent the original sensor data of a single sensor of the arrangement.

It may be provided that the sensor arrangement can have two or more than two, in particular three or more than three, in particular four or more than four, in particular five or more than five, in particular six or more than six, in particular seven or more than seven, in particular eight or more than eight, in particular nine or more than nine, in particular ten or more than ten, sensors, and/or wherein all sensors of the arrangement are of the same type.

For example, the sensors of the arrangement, in particular the specific sensor and the auxiliary sensors, are or all or at least in part current measurement sensors, voltage measurement sensors, force sensors, load cells, acceleration sensors, motion sensors, velocity sensors, rotational speed sensors, temperature sensors, ultrasonic sensors, and/or eddy current sensors.

According to a second aspect, the object is achieved by the invention in that an apparatus for data processing, in particular having one or more interfaces for receiving sensor data from a plurality of sensors, is proposed, wherein the apparatus is suitable for carrying out a method according to the first aspect of the invention.

The apparatus for data processing may, for example, be implemented in software, in hardware, or a combination of both. The apparatus for data processing may alternatively or additionally include a memory (in particular for storing the first, second, and/or third machine learning data model), a processor, a receiving device, a transmitting device (for example for transmitting the original sensor data, in particular the control signal, to an internal or external entity), or any given combination thereof. The apparatus for data processing preferably has one or more interfaces for receiving sensor data from a plurality of sensors (in particular the plurality of sensors of the sensor arrangement used in the method according to the first aspect of the invention).

According to a third aspect, the object is achieved by the invention in that a sensor arrangement, in particular in the form of a plurality of sensors, is proposed that is suitable for use in a method according to the first aspect of the invention and/or for cooperation with an apparatus for data processing according to the second aspect of the invention.

The statements made with regard to the first aspect of the invention also apply with regard to the third aspect of the invention, unless specified otherwise from the context. In particular, all advantages and features explained with regard to the sensor arrangement used in a method according to the first aspect of the invention correspondingly apply in their entirety here as well. In this regard, reference may therefore be made to the above statements.

Therefore, all features explained with regard to the sensor arrangement used in a method according to the first aspect of the invention may be provided, individually or in any given combination, for the sensor arrangement according to the third aspect of the invention.

According to a fourth aspect, the object is achieved by the invention in that a device, in particular a machine, having a sensor arrangement according to the third aspect of the invention situated thereon and/or having such a sensor arrangement and/or having an apparatus for data processing according to the second aspect of the invention, are/is proposed.

The statements made with regard to the first and second aspects of the invention also apply with regard to the fourth aspect of the invention, unless specified otherwise from the context. In particular, all advantages and features explained with regard to the sensor arrangement used in a method according to the first aspect of the invention and with regard to a sensor arrangement according to the third aspect of the invention, and alternatively or additionally with regard to an apparatus for data processing according to the second aspect of the invention, correspondingly apply in their entirety here as well. In this regard, reference may therefore be made to the above statements.

Therefore, all features explained with regard to the sensor arrangement used in a method according to the first aspect of the invention, with regard to the sensor arrangement according to the third aspect of the invention, and/or with regard to the apparatus for data processing according to the second aspect of the invention, may be provided, individually or in any given combination, for the sensor arrangement and/or the apparatus for data processing of the device according to the fourth aspect of the invention.

The device can be a conveying device, measuring device, weighing device, grinding device, mixing device, filtering device, screening device, drying device, and/or metering device or includes same.

It may be provided that (i) the device is or includes a platform scale, and/or the sensors of the sensor arrangement are load cells, (ii) the device is or includes a screen, and/or the sensors of the sensor arrangement are motion sensors and/or acceleration sensors, (iii) the device is or includes a metering device, and/or the sensors of the sensor arrangement are rotational speed sensors and/or load cells, (iv) the device is or includes a belt scale, and/or the sensors of the sensor arrangement are load cells, and/or (v) the device is or includes a crane scale, and/or the sensors of the sensor arrangement are force sensors, in particular load cells.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of a sensor arrangement according to an example of the invention, together with an apparatus for data processing according to an example of the invention;

FIG. 2 shows a schematic view of a device according to an example of the invention;

FIG. 3 shows a flow chart of a method according to an example of the invention; and

FIG. 4 shows patterns of actual sensor data and calculated replacement sensor data in comparison.

### DETAILED DESCRIPTION

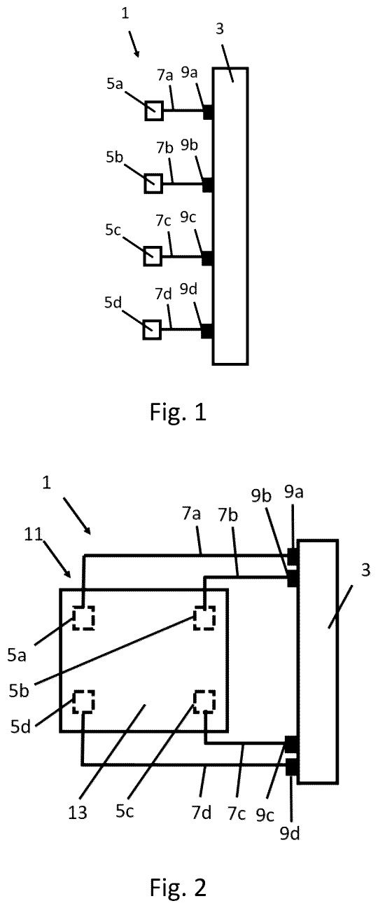

FIG. 1 shows a schematic view of a sensor arrangement 1 according to an example of the invention, which is in operative connection with an apparatus for data processing 3 according to an example of the invention.

The sensor arrangement 1 has four identical sensors 5a through 5d, each in the form of a load cell. Each sensor 5a through 5d is connected to a respective interface 9a through 9d of the apparatus 3 via a transmission channel 7a through 7d, respectively, in each case in the form of a cable. The apparatus 3 is configured to carry out a method according to the first aspect of the invention.

The sensor arrangement 1 may advantageously be used with a platform scale, as implemented by the device 11 according to the fourth aspect of the invention, schematically illustrated in FIG. 2, and shown in FIG. 2 together with the apparatus for data processing 3. The platform scale has a support surface 13 on which an object to be weighed may be placed, and which is supported on the sensors 5a through 5d (which are concealed by the support surface 13 in FIG. 2 and therefore depicted only as dashed lines) of the sensor arrangement 1. When an object is placed on the support surface 13, its weight force causes a force to act on the sensors 5a through 5d. Each sensor 5a through 5d generates sensor data, in the form of digital measured values, corresponding to the particular action of force.

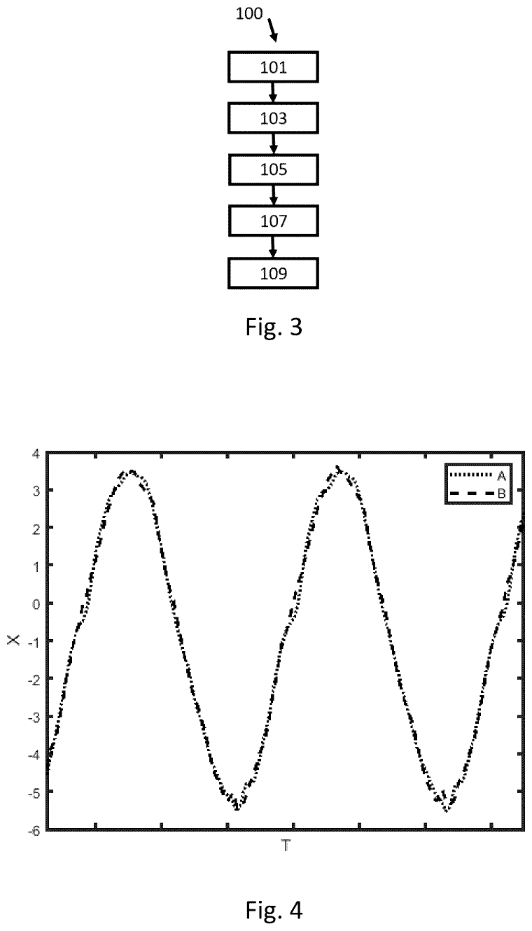

FIG. 3 shows a flow chart 100 of a method according to the first aspect of the invention.

In 101, during operation of the sensor arrangement 1, sensor data of the individual sensors 5a through 5d are received by the apparatus 3 as reception sensor data via the transmission channels 7a through 7d, and provided as original sensor data (for example, to a process within software). In the case of load cells, the received sensor data vary over time, corresponding to the force that acts on the individual sensors as a function of time. All sensors continuously receive the current sensor data in parallel. At least during error-free operation of the sensor arrangement 1, the received reception sensor data of each sensor are advantageously identical to the provided original sensor data of the particular sensor.

As the result of a failure of one of the sensors, for example sensor 5a, which for better reference is then designated as the specific sensor, beginning at a certain point in time the apparatus 3 no longer receives sensor data from the specific sensor 5a. The failure of the sensor may be caused, for example, by a defect within the specific sensor 5a or a (for example, physical) interruption of the transmission channel 7a (due to a severed cable, for example).

Due to the fact that the specific sensor 5a no longer receives sensor data, an error state in conjunction with the specific sensor 5a is identified in 103.

Training of a first machine learning data model is subsequently carried out in 105.

For this purpose, the other three sensors 5b through 5d of the arrangement 1 are selected as auxiliary sensors, and their reception sensor data from the last two days prior to identifying the error state are used as input data for the training. At the same time, the reception sensor data of the specific sensor 5a from the last two days prior to identifying the error state are used as truth data, associated with the input data, for the training. The reception sensor data from the last two days are thus historical sensor data. A linear relationship between the historical sensor data of the specific sensor 5a on the one hand and the historical sensor data of the auxiliary sensors 5b through 5d on the other hand is assumed.

It must be ensured that in the time period from which the historical sensor data of the sensors 5a through 5d originate, i.e., the last two days, no error state has been identified for any of the sensors 5a through 5d. If this had been the case, for example a shorter or time-shifted time period would have been selected in which no error state had been identified, and the historical sensor data of the sensors 5a through 5d from this time period could have been used.

As soon as the training of the first machine learning data model is completed, in 107 the reception sensor data of the auxiliary sensors 5b through 5d are used as input data for the first data model. The result data obtained as replacement sensor data by the computation of the trained data model are provided as original sensor data of the specific sensor 5a. This means that the provided original sensor data of the auxiliary sensors 5b through 5d continue to be the reception sensor data received from these sensors 5b through 5d, while the provided original sensor data of the specific sensor 5a are the determined replacement sensor data.

After a certain period of time the sensor 5a once again functions properly, for example because the defective sensor 5a has been repaired or replaced, so that the apparatus 3 once again receives sensor data from the specific sensor 5a.

A discontinuation of the error state in conjunction with the specific sensor 5a is thus identified in 109. The reception sensor data of the specific sensor 5a are then once again received and provided as original sensor data of the specific sensor 5a. In particular, the replacement sensor data are thus no longer used. It is then possible, for example, to also end the use of the first trained machine learning data model. The received reception sensor data of each sensor are then once again identical to the provided original sensor data of the particular sensor.

FIG. 4 shows the pattern of the sensor data (curve A) received from an actual sensor of a sensor arrangement according to the invention during a specific time period, together with the pattern of replacement sensor data, computed by a trained machine learning data model for this time period, for the same actual sensor (curve B). The sensor arrangement had four sensors. The machine learning data model used was trained based on historical sensor data of the four sensors, similarly as for the first machine learning data model used in the method described with reference to the flow chart in FIG. 3. During the time period illustrated in the diagram in FIG. 4 (time axis T), the trained machine learning data model was computed using the current sensor data of the other three sensors in order to determine the represented replacement sensor data (curve B) for the sensor.

The virtually identical pattern of the two curves A and B confirms the particularly advantageous and reliable functioning of the proposed method according to the first aspect of the invention for the operation of a sensor arrangement.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a sensor arrangement comprising at least two sensors, the method comprising:
receiving sensor data from each of the at least two sensors as reception sensor data of the particular sensor and provided as original sensor data of the particular sensor for further data processing;
identifying an error state in conjunction with at least one specific sensor of the at least two sensors; and
determining replacement sensor data for the specific sensor, the determined replacement sensor data being used instead of reception sensor data of the specific sensor and provided as original sensor data of the specific sensor, wherein the replacement sensor data are determined using at least one first trained machine learning data model, and the reception sensor data and/or original sensor data of at least one sensor which is selected from the plurality of sensors as an auxiliary sensor, and which is not the specific sensor, and/or data based thereon, are used, at least in part, as input data for the first trained machine learning data model.

2. The method according to claim 1, wherein the training of the first machine learning data model is carried out after the error state is identified.

3. The method according to claim 1, wherein the training of the first machine learning data model is or has been carried out at least using historical sensor data or historical reception sensor data of the specific sensor and/or historical sensor data or historical reception sensor data of at least one sensor or all sensors of the at least one auxiliary sensor.

4. The method according to claim 1, wherein the training of the first machine learning data model encompasses assuming a linear relationship between the historical sensor data of the specific sensor and the historical sensor data of the auxiliary sensors.

5. The method according to claim 3, wherein the historical sensor data of the specific sensor and the historical sensor data of the auxiliary sensors have been detected within the same time window.

6. The method according to claim 3, wherein the historical sensor data of the specific sensor and/or of the auxiliary sensors are the reception sensor data received during a defined or definable time period prior to identifying the error state, or are data of the particular sensors provided as original sensor data, and wherein (i) within the time period, no error state has been identified, either for the specific sensor or for one of the auxiliary sensors, and/or (ii) sensors of the plurality of sensors for which an error state has been identified within the time period are not selected as auxiliary sensors.

7. The method according to claim 1, wherein the sensor data or the historical sensor data of the specific sensor at least slightly correlate with the sensor data or the historical sensor data of each auxiliary sensor.

8. The method according to claim 1, wherein an error state for the specific sensor is identified:
(i) when sensor data are no longer received, at least temporarily, from the specific sensor,
(ii) when the reception sensor data received from the specific sensor or a statistical value thereof are/is above or below a defined or definable threshold value,
(iii) when the reception sensor data received from the specific sensor do not meet a defined or definable measure of quality,
(iv) when a result of testing an electrical resistance of the specific sensor, in particular in the form of a load cell, indicates a defect of the sensor, and/or
(v) when a value or a maximum value of a correlation between the received reception sensor data of the specific sensor and the received reception sensor data of at least one other sensor of the plurality of sensors, in particular of the auxiliary sensors, is above or below a defined or definable threshold value.

9. The method according to claim 1, wherein, after the error state is identified in conjunction with the specific sensor, a discontinuation of the error state in conjunction with the specific sensor is identified, and the reception sensor data of the specific sensor are subsequently once again received and/or provided as original sensor data of the specific sensor, and wherein the replacement sensor data are no longer provided as original sensor data of the specific sensor.

10. The method according to claim 1, wherein the reception sensor data from each sensor of the plurality of sensors are continuously received, the reception sensor data are received in parallel from all sensors of the plurality of sensors, and/or the result data of the first trained machine learning data model are used as replacement sensor data.

11. The method according to claim 1, wherein for at least the specific sensor, a second machine learning data model in trained form is kept ready, and the determination of the replacement sensor data encompasses determining, by the second trained machine learning data model that is kept ready for the specific sensor, the replacement sensor data, at least temporarily, or at least until the training of the first machine learning data model is completed, the second trained machine learning data model being substantially identical to the first trained machine learning data model.

12. The method according to claim 1, wherein for at least the specific sensor, a third machine learning data model in trained form is kept ready, the third trained machine learning data model being identical to the second trained machine learning data model, and by use of the third trained machine learning data model, test sensor data for the specific sensor are determined at least temporarily, preferably continuously, and compared to the sensor data received from the specific sensor, and an error state for the specific sensor is identified based on a result of the comparison.

13. The method according to claim 1, wherein the reception sensor data and/or the original sensor data are associated or associatable with the individual sensors in each case, and/or wherein the original sensor data are provided to a process, to a module, to a device, and/or in the form of a control signal.

14. The method according to claim 1, wherein the sensor arrangement has two or more than two, or three or more than three, or four or more than four, or five or more than five, or six or more than six, or seven or more than seven, or eight or more than eight, or nine or more than nine, or ten or more than ten, sensors, and/or wherein all sensors of the arrangement are of the same type.

15. An apparatus for data processing, comprising one or more interfaces for receiving sensor data from a plurality of sensors, wherein the apparatus is adapted to carry out the method according to claim 1.

16. A sensor arrangement in the form of a plurality of sensors adapted for the method according to claim 1 and/or for cooperation with an apparatus for data processing.

17. A device having a sensor arrangement according to claim 16 situated thereon and/or having such a sensor arrangement and/or having an apparatus for data processing.

18. The device according to claim 17, wherein (i) the device is or includes a platform scale, and/or the sensors of the sensor arrangement are load cells, (ii) the device is or includes a screen, and/or the sensors of the sensor arrangement are motion sensors and/or acceleration sensors, (iii) the device is or includes a metering device, and/or the sensors of the sensor arrangement are rotational speed sensors and/or load cells, (iv) the device is or includes a belt scale, and/or the sensors of the sensor arrangement are load cells, and/or (v) the device is or includes a crane scale, and/or the sensors of the sensor arrangement are force sensors, in particular load cells.
